(19) United States
(12) Patent Application Publication
(10) Pub. No.: US 2024/0404766 A1
(43) Pub. Date: Dec. 5, 2024

(54) CIRCUIT BREAKER AND METHOD

(71) Applicant: Siemens Aktiengesellschaft, München (DE)

(72) Inventor: Marvin Tannhäuser, Hausen (DE)

(21) Appl. No.: 18/696,497

(22) PCT Filed: Sep. 5, 2022
(86) PCT No.: PCT/EP2022/074580

§ 371 Date: Mar. 28, 2024

(30) Foreign Application Priority Data
Sep. 28, 2021 (DE) 10 2021 210 812.1

(51) Int. Cl. H01H 9/54; H02H 3/02; H02H 3/06; H02H 3/08

(52) U.S. Cl. CPC H01H 9/547; H01H 9/548; H02H 3/023; H02H 3/066; H02H 3/08

(57) ABSTRACT

A circuit breaker protecting electric low-voltage circuits includes a housing with grid and load-side connections and a mechanical isolating contact unit connected to an electronic interruption unit. The isolating contact unit pairs with load-side, and the electronic interruption unit pairs with grid-side, connections. The isolating contact unit switches by opening contacts preventing, or closing contacts permitting, current flow in the low-voltage circuit. The electronic interruption unit switches to high-ohmic state of semiconductor-based switch elements preventing, or low-ohmic state permitting, current flow in the low-voltage circuit. Current level in the low-voltage circuit is ascertained. Current flow prevention in the low-voltage circuit initiates upon exceeding current and/or current/time thresholds. With contacts closed and the electronic interruption unit switched to high-ohmic state, the electronic interruption unit switches to low-ohmic state for a first duration checking circuit breaker functionality.

The invention relates to the technical field of a circuit breaker for low-voltage circuit with an electronic interruption unit and a method for a circuit breaker for a low-voltage circuit with an electronic interruption unit.

Low-voltage refers to voltages of up to 1000 volts AC or up to 1500 volts DC. Low-voltage refers in particular to voltages that are greater than extra-low voltage, with values of 50 volts AC or 120 volts DC.

A low-voltage circuit or network or system refers to circuits with nominal currents or rated currents of up to 125 amperes, more specifically up to 63 amperes. Low-voltage circuits refers in particular to circuits with nominal currents or rated currents of up to 50 amperes, 40 amperes, 32 amperes, 25 amperes, 16 amperes or 10 amperes. The aforementioned current values refer in particular to nominal, rated and/or cut-off currents, i.e., the maximum current that is normally conducted via the circuit or at which the electric circuit is usually interrupted, for example by a protective device such as a circuit breaker, miniature circuit breaker or power switch. The rated currents can vary further, from 0.5 A through 1 A, 2 A, 3 A, 4 A, 5 A, 6 A, 7 A, 8 A, 9 A, 10 A, etc. up to 16 A.

Miniature circuit breakers have long been known as overcurrent protection devices used in low-voltage circuits in electrical installation technology. They protect cables from damage caused by heating due to excessive current and/or short circuits. A miniature circuit breaker can automatically switch off the circuit in the event of an overload and/or short circuit. A miniature circuit breaker is a non-automatically resetting fuse element.

In contrast to miniature circuit breakers, power switches are designed for currents greater than 125 A, sometimes even as low as 63 amps. Miniature circuit breakers are therefore simpler and more delicate in design. Miniature circuit breakers usually have a mounting option for attachment to a so-called top-hat rail (mounting rail, DIN rail, TH35).

Miniature circuit breakers have an electromechanical design. They have a mechanical switching contact or shunt release in a housing for interrupting (tripping) the electrical current. A bimetallic protective element or bimetallic element is usually used for tripping (interruption) in the event of prolonged overcurrent (overcurrent protection) or thermal overload (overload protection). An electromagnetic release with a coil is used for short-time tripping when an overcurrent limit value is exceeded or in the event of a short circuit (short-circuit protection). One or more arc quenching chamber(s) or devices for arc quenching are provided. Furthermore, connection elements are provided for conductors of the electric circuit to be protected.

Circuit breakers with an electronic interruption unit are relatively new developments. These have a semiconductor-based electronic interruption unit. This means that the electrical current flow of the low-voltage circuit is routed via semiconductor components or semiconductor switches, which interrupt the electrical current flow or can be switched conductively. Furthermore, circuit breakers with an electronic interruption unit often have a mechanical separating contact system, in particular with isolating properties in accordance with the relevant standards for low-voltage circuits, wherein the contacts of the mechanical separating contact system are connected in series with the electronic interruption unit, i.e., the current of the low-voltage circuit to be protected is conducted via both the mechanical separating contact system and the electronic interruption unit.

The present invention relates in particular to low-voltage AC circuits with an AC voltage, usually with a time-dependent sinusoidal AC voltage with the frequency f. The time dependence of the instantaneous voltage value u(t) of the AC voltage is described by the equation:

$$u ( t ) = U * sin ( 2 π * f * t ) .$$

Where:
u(t)=instantaneous voltage value at time t
U=amplitude of the voltage

A harmonic alternating voltage can be represented by the rotation of a pointer, the length of which corresponds to the amplitude (U) of the voltage. The instantaneous deflection here is the projection of the pointer onto a coordinate system. One oscillation period corresponds to one full rotation of the pointer and its full angle is 2π (2Pi) or 360°. The angular frequency is the rate of change of the phase angle of this rotating pointer. The angular frequency of a harmonic oscillation is always 2π times its frequency, i.e.:

$$ω = 2 π * f = 2 π / T = angular frequency of the alternating voltage ( T = period duration of the oscillation )$$

It is often preferred to specify the angular frequency (ω) rather than the frequency (f), as many formulas in vibration theory can be represented more compactly using the angular frequency due to the occurrence of trigonometric functions of which the period is 2π by definition:

$$u ( t ) = U * sin ( ω t )$$

In the case of non-time-constant angular frequencies, the term instantaneous angular frequency is also used.

In the case of a sinusoidal, in particular time-constant, alternating voltage, the time-dependent value from the angular velocity ω and the time t corresponds to the time-dependent angle φ(t), which is also referred to as the phase angle φ(t). This means that the phase angle φ(t) periodically runs through the range 0 . . . 2π or 0° . . . 360°. This means that the phase angle periodically assumes a value between 0 and 2π or 0° and 360° ( =n*(0 . . . 2π) or φ=n*(0° . . . 360°), due to periodicity; abbreviated: φ=0 . . . 2π or φ=0° . . . 360°).

The instantaneous voltage value u(t) is therefore the instantaneous value of the voltage at time t, i.e., in the case of a sinusoidal (periodic) AC voltage, the value of the voltage at the phase angle φ (φ=0 . . . 2π or φ=0° . . . 360°, of the respective period).

The object of the present invention is to improve a circuit breaker of the type mentioned at the outset, in particular to improve the safety of such a circuit breaker or to achieve a higher level of safety in the electric low-voltage circuit to be protected by the circuit breaker.

This object is achieved by a circuit breaker having the features of claim 1 and by a method according to claim 14.

According to the invention, a circuit breaker for protecting an electric low-voltage circuit, in particular a low-voltage AC circuit, is proposed, comprising:
a housing with at least one grid-side connection and one load-side connection,
a mechanical isolating contact unit which is connected in series with an electronic interruption unit, wherein the mechanical isolating contact unit is paired with the load-side connection and the electronic interruption unit is paired with the grid-side connection,
the mechanical isolating contact unit can be switched by opening contacts to prevent a current flow or by closing the contacts for a current flow in the low-voltage circuit,
the electronic interruption unit can be switched by semiconductor-based switch elements into a high-ohmic state of the switch elements to prevent current flow or into a low-ohmic state of the switch elements for a current flow in the low-voltage circuit,
a current sensor unit to determine the level of current in the low-voltage circuit,
a control unit which is connected to the current sensor unit, the mechanical isolating contact unit and the electronic interruption unit, wherein a prevention of a current flow of the low-voltage circuit is initiated when current and/or current-time limit values are exceeded.

According to the invention, the circuit breaker is designed in such a way that the electronic interruption unit is switched to a low-ohmic state for a first period of time in order to test the function of the circuit breaker when the contacts of the mechanical isolating contact unit are closed and the electronic interruption unit is switched to a high-ohmic state. This means that the electronic interruption unit is switched from the high-ohmic state to the low-ohmic state for a first period of time and is then in the high-ohmic state again.

The first time span can be in the range 100 us to 1 ms. For example, 100 μs, 200 μs, . . . , 1 ms; any intermediate value is possible and disclosed. This has the particular advantage that the electronic interruption unit can be tested with regard to its “switch-on capability”. In accordance with the invention, increased operational reliability of a circuit breaker is thus achieved. Furthermore, a new architecture or constructive design of a circuit breaker is proposed.

Advantageous embodiments of the invention are given in the dependent claims and in the exemplary embodiment.

In an advantageous embodiment of the invention, the circuit breaker is designed in such a way that the voltage level across the electronic interruption unit can be determined (for a conductor).

This has the particular advantage that the voltage level between the grid-side connection point and the load-side connection point of the electronic interruption unit can be determined.

At least one voltage sensor unit connected to the control unit can be provided for this purpose. If there are several voltage sensor units, these are connected to the control unit.

Determining the voltage level across the electronic interruption unit is an advantageous and simple way to help determine the functionality of the electronic interruption unit. This results in increased operational reliability of a circuit breaker. Furthermore, a new architecture or design of a circuit breaker is proposed.

In an advantageous embodiment of the invention, the circuit breaker is designed in such a way that when the electronic interruption unit is switched to the low-ohmic state for the first time period, the level of the voltage across the electronic interruption unit is determined. Here (in the low-ohmic state), the level of the voltage across the electronic interruption unit is determined. If a first voltage threshold value is exceeded, a first fault condition is present, so that a (particularly further) low-ohmic state (or renewed low-ohmic state) of the electronic interruption unit is avoided and/or opening of the contacts is initiated.

The first voltage threshold value should preferably be less than 1 V. The first voltage threshold value can be between 0 volts (or greater than 0 volts) and less (e.g. 10% less) than the instantaneous value of the currently applied AC voltage (especially when monitoring or comparing instantaneous values).

The first time span can be very short. For example, the second time span can be less than 1 ms, specifically for example 500 μs or 100 μs.

This has the particular advantage that the switch-on capability of the electronic interruption unit can also be tested in this operating state.

In an advantageous embodiment of the invention, the electronic interruption unit is switched to a low-ohmic state when the instantaneous value of the voltage between the grid-side neutral conductor connection and the grid-side phase conductor connection falls below a second voltage threshold value.

The second voltage threshold can be a value of the (protective) extra-low voltage. For example, the second voltage threshold can be 50 V or less.

This has the particular advantage that the electronic interruption unit is tested with regard to its switch-on capability with a safe voltage or at safe times of the (instantaneous) voltage level. This ensures a high level of operational safety while at the same time testing the circuit breaker.

In an advantageous embodiment of the invention, a first voltage sensor unit connected to the control unit is provided, which determines the level of a first voltage between a grid-side connection point and a load-side connection point of the electronic interruption unit.

This has the particular advantage of providing a simple solution with only one voltage sensor unit.

In an advantageous embodiment of the invention, a second voltage sensor unit connected to the control unit is alternatively provided and determines the level of a second voltage between the grid-side neutral conductor connection and the grid-side phase conductor connection. Furthermore, a third voltage sensor unit connected to the control unit is provided, which determines the level of a third voltage between the grid-side neutral conductor connection and the load-side connection point of the electronic interruption unit. The circuit breaker is designed in such a way that the level of a first voltage between the grid-side connection point and the load-side connection point of the electronic interruption unit is determined from the difference between the second and third voltage.

This has the particular advantage of providing a further solution based on classic voltage measurements. It also enables more extensive testing of the circuit breaker.

In an advantageous embodiment of the invention, the current sensor unit is provided on the circuit side between the grid-side phase conductor connection and the load-side phase conductor connection.

This has the particular advantage that the device can be divided into two compact parts, with an electronic interruption unit in the phase conductor together with a current sensor unit on the one hand and a continuous neutral conductor on the other. Furthermore, a current sensor unit in the phase conductor enables more extensive monitoring of currents both in the circuit itself and in the event of earth fault currents.

In an advantageous embodiment of the invention, the low-voltage circuit is a three-phase alternating current circuit.

The circuit breaker has further grid-side and load-side phase conductor connections in order to protect the phases of the electric circuit. An electronic interruption unit with a voltage detection system according to the invention, in particular first voltage sensor units, is provided between each of the grid-side and load-side phase conductor connections. A contact of the mechanical isolating contact unit is also provided between each of the grid-side and load-side phase conductor connections.

This has the particular advantage of providing protection for three-phase AC circuits.

In an advantageous embodiment of the invention, the circuit breaker is designed in such a way that the contacts of the mechanical isolating contact unit can be opened by the control unit, but not closed.

This has the particular advantage that increased operational safety is achieved, as the contacts cannot be closed accidentally by the control unit.

In an advantageous embodiment of the invention, the mechanical isolating contact unit can be operated by a mechanical handle in order to switch the opening of contacts or the closing of contacts.

This has the particular advantage of providing the functionality of a classic miniature circuit breaker.

In an advantageous embodiment of the invention, a power supply is provided, in particular for the control unit, which is connected to the grid-side neutral conductor connection and the grid-side phase conductor connection. In particular, a fuse, especially a melting fuse, is provided in the connection to the grid-side neutral conductor connection. Advantageously, the measuring impedance in particular can be connected to the grid-side neutral conductor connection via the fuse.

This has the particular advantage of enabling a compact electronic assembly. Furthermore, there is only one cross-connection between the phase conductor and neutral conductor, so that a fault in the device, which would cause a short circuit here, is easy to protect against.

In an advantageous embodiment of the invention, with closed contacts of the mechanical isolating contact unit and low-ohmic interruption unit and
when a current is detected that exceeds a first current value, in particular the first current value is exceeded for a first time limit, the electronic interruption unit becomes high-ohmic and the mechanical isolating contact unit remains closed,
when a current is detected that exceeds a (higher) second current value, in particular for a second time limit, the electronic interruption unit becomes high-ohmic and the mechanical isolating contact unit is opened,
if a current is detected that exceeds an (even higher) third current value, the electronic interruption unit becomes high-ohmic and the mechanical isolating contact unit is opened.

This has the particular advantage that there is a graduated switch-off concept for increased currents for a circuit breaker according to the invention.

In an advantageous embodiment of the invention, the control unit has a microcontroller.

This has the particular advantage that the functions according to the invention for increasing the safety of a circuit breaker or the electrical low-voltage circuit to be protected can be implemented by a (customizable) computer program product. Furthermore, changes and improvements to the function can thus be individually loaded onto a circuit breaker.

According to the invention, a corresponding method is claimed for a circuit breaker for an electric low-voltage circuit with electronic (semiconductor-based) switch elements with the same and further advantages.

The method for a circuit breaker for protecting an electric low-voltage circuit with:
a housing with at least one grid-side connection and one load-side connection,
a mechanical isolating contact unit connected in series with an electronic interruption unit, wherein the mechanical isolating contact unit is paired with the load-side connection and the electronic interruption unit is paired with the grid-side connection,
the mechanical isolating contact unit can be switched by opening contacts to prevent a current flow or by closing the contacts for a current flow in the low-voltage circuit,
the electronic interruption unit can be switched by semiconductor-based switch elements into a high-ohmic state of the switch elements to prevent current flow or into a low-ohmic state of the switch elements for a current flow in the low-voltage circuit,
the level of the current in the low-voltage circuit, in particular between the grid-side phase conductor connection and the load-side phase conductor connection, is determined,
if current and/or current/time limit values are exceeded, prevention of a current flow in the low-voltage circuit is initiated.

To test the function of the circuit breaker when the contacts of the mechanical isolating contact unit are closed and the electronic interruption unit is switched to a high-ohmic state, the electronic interruption unit is switched to a low-ohmic state for a first period of time.

When the electronic interruption unit is switched to the low-ohmic state for the first period of time, the voltage level across the electronic interruption unit is determined. If a first voltage threshold value is exceeded (in the low-ohmic state), a first fault condition is present, so that a further low-ohmic state of the electronic interruption unit is avoided and/or opening of the contacts is initiated.

Advantageously, the electronic interruption unit is then switched to a low-ohmic state when the instantaneous value of the voltage between the grid-side neutral conductor connection and the grid-side phase conductor connection falls below a second voltage threshold value.

According to the invention, a corresponding computer program product is claimed. The computer program product comprises instructions which, when the program is executed by a microcontroller, cause the microcontroller to improve the safety of such a circuit breaker or to achieve a higher level of safety in the electric low-voltage circuit to be protected by the circuit breaker.

The microcontroller is part of the circuit breaker, in particular the control unit.

According to the invention, a corresponding computer-readable storage medium on which the computer program product is stored is claimed.

According to the invention, a corresponding data carrier signal transmitting the computer program product is claimed.

All embodiments, both in dependent form with reference back to claim 1 or 14, as well as with reference back only to individual features or combinations of features of claims, in particular also a reference back of the dependent arrangement claims to the independent method claim, bring about an improvement in a circuit breaker, in particular an improvement in the safety of a circuit breaker or the electric circuit, and provide a new concept for a circuit breaker.

The described properties, features and advantages of the present invention and the manner in which they are achieved will become clearer and more comprehensible in conjunction with the following description of the exemplary embodiments which are explained in greater detail in conjunction with the drawing, in which:

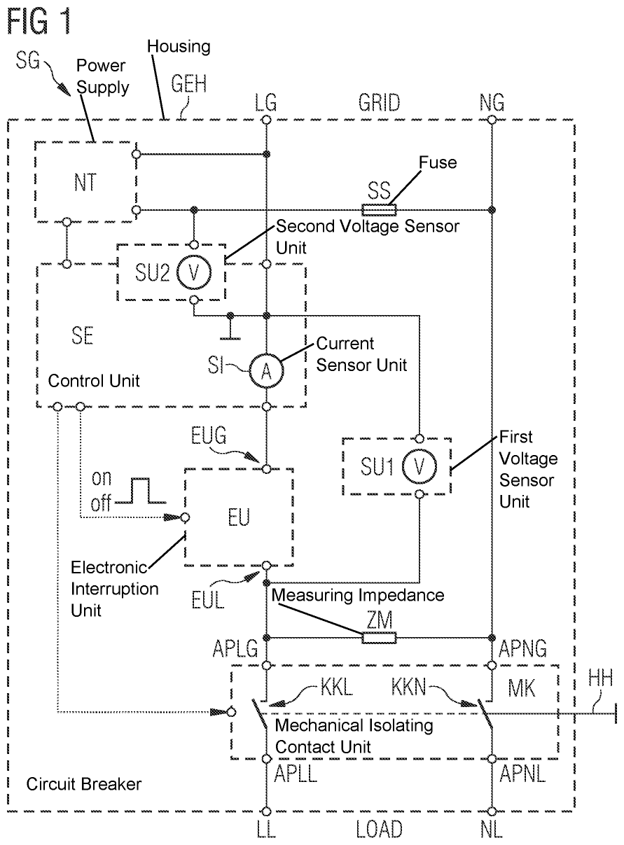

FIG. 1 shows a first representation of a circuit breaker,

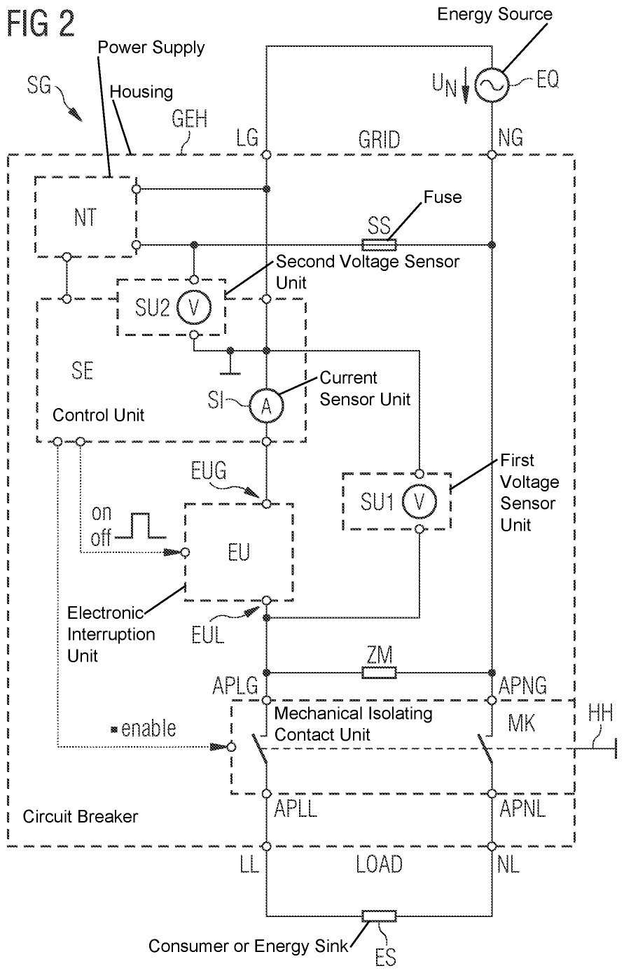

FIG. 2 shows a second representation of a circuit breaker,

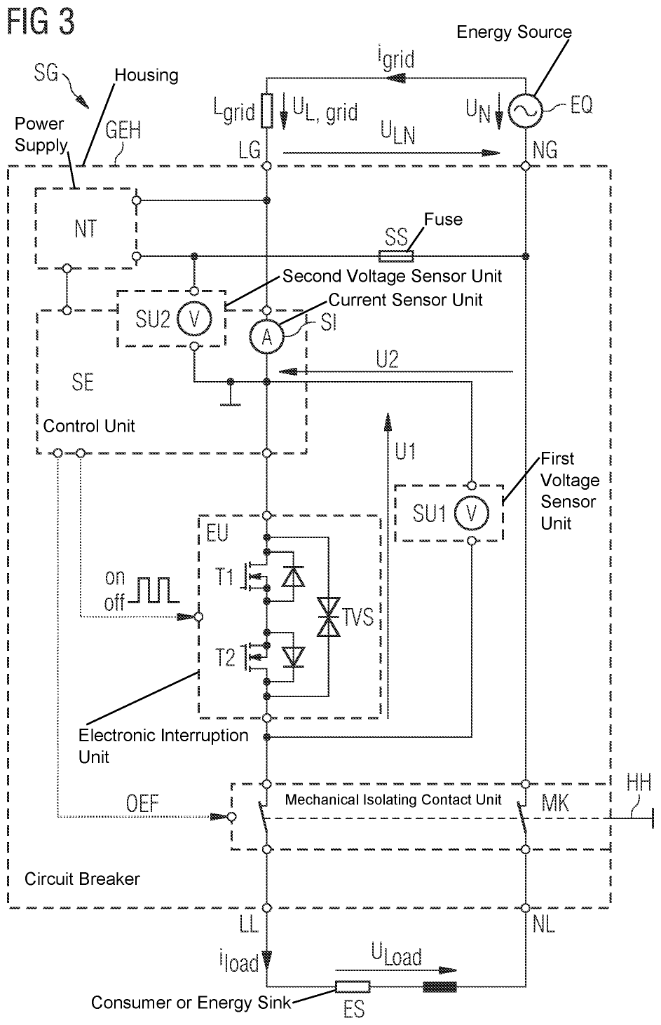

FIG. 3 shows a third representation of a circuit breaker,

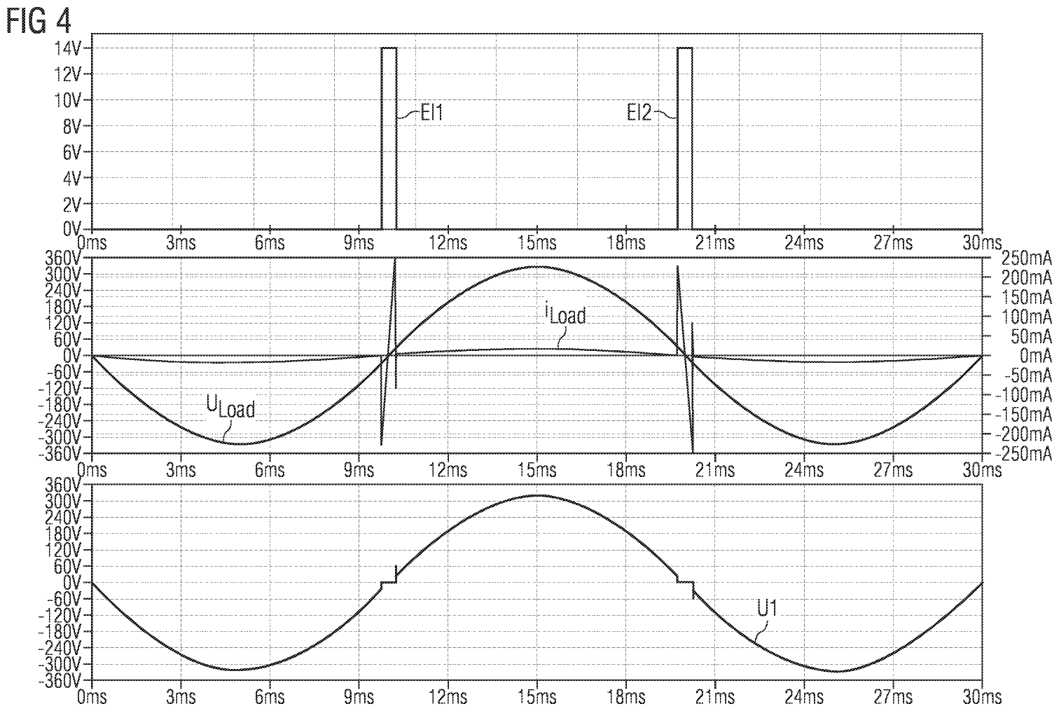

FIG. 4 shows a representation with first voltage curves,

FIG. 5 shows a representation with second voltage curves,

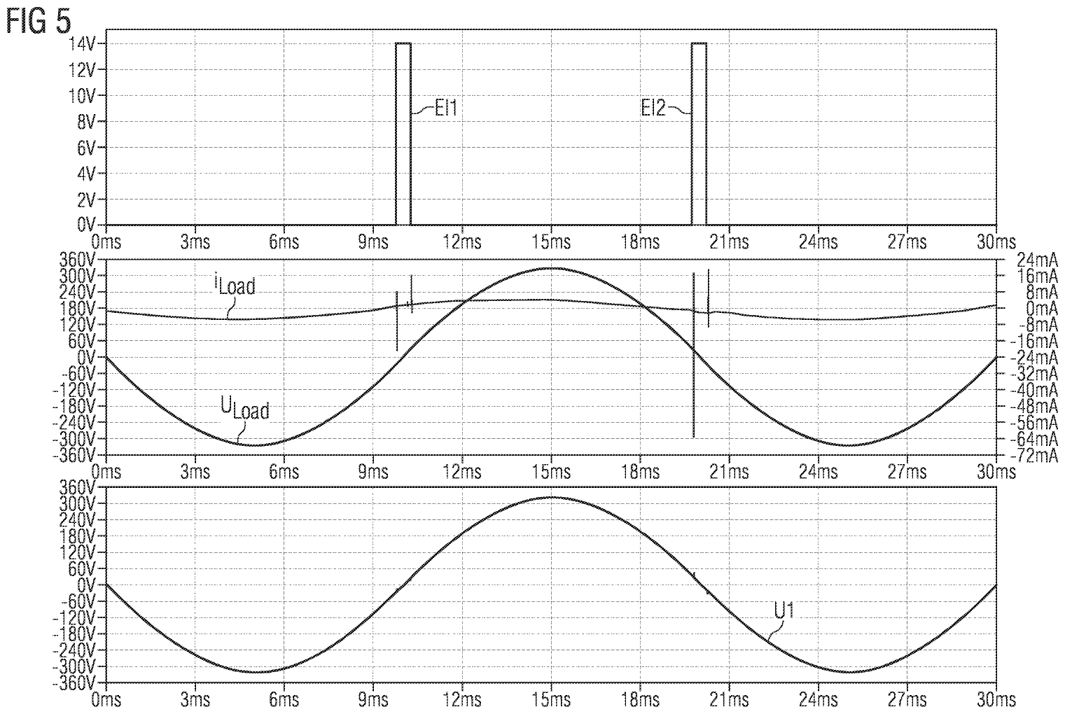

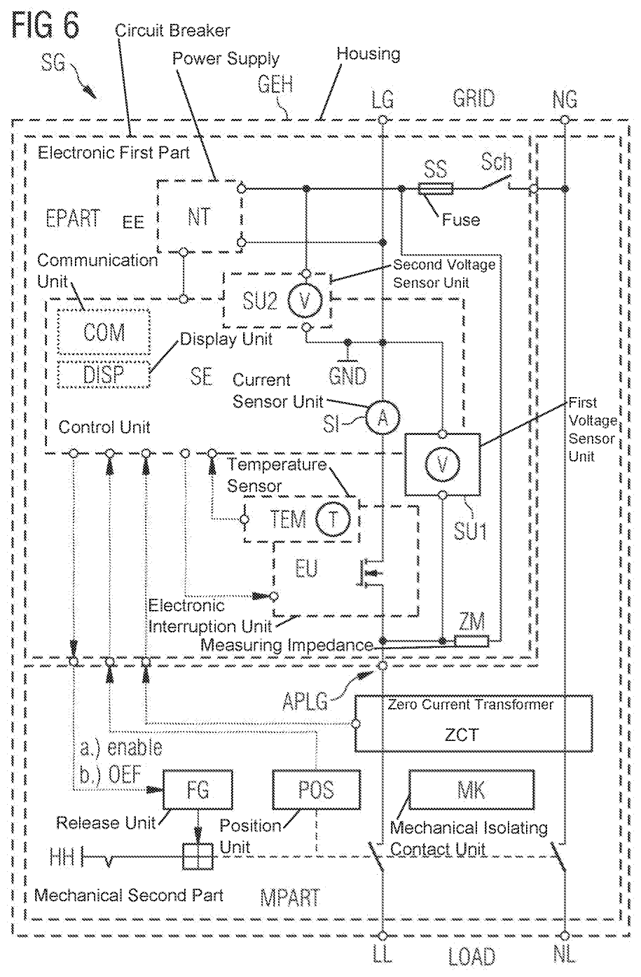

FIG. 6 shows a fourth representation of a circuit breaker.

FIG. 1 shows a representation of a circuit breaker SG for protecting an electric low-voltage circuit, in particular a low-voltage AC circuit, with a housing GEH, comprising:
a grid-side neutral conductor connection NG, a grid-side phase conductor connection LG, a load-side neutral conductor connection NL, a load-side phase conductor connection LL of the low-voltage circuit;
   an energy source is usually connected to the grid side GRID,
   a consumer is usually connected to the load side LOAD;
a (two-pole) mechanical isolating contact unit MK with load-side connection points APLL, APNL and grid-side connection points APLG, APNG,
   wherein a load-side connection point APNL is provided for the neutral conductor, a load-side connection point APLL for the phase conductor, a grid-side connection point APNG for the neutral conductor and a grid-side connection point APLG for the phase conductor. The load-side connection points APNL, APLL are connected to the load-side neutral and phase conductor connections NL, LL, so that opening of contacts KKN, KKL to prevent a current flow or closing of the contacts for a current flow in the low-voltage circuit is switchable,
an, in particular single-pole, electronic interruption unit EU (which is arranged in particular in the phase conductor in the case of a single-pole version)
   with a grid-side connection point EUG, which is electrically connected to the grid-side phase conductor connection LG, and
   a load-side connection point EUL, which is electrically connected to the grid-side connection point APLG of the mechanical isolating contact unit MK, wherein the electronic interruption unit has a high-ohmic state of the switch elements to prevent current flow or into a low-ohmic state of the switch elements for a current flow in the low-voltage circuit by means of semiconductor-based switch elements,
a current sensor unit SI, for determining the level of the current of the low-voltage circuit, which is arranged in particular in the phase conductor,
a control unit SE, which is connected to the current sensor unit SI, the mechanical isolating contact unit MK and the electronic interruption unit EU, wherein a prevention of a current flow of the low-voltage circuit is initiated when current and/or current-time limit values are exceeded.

According to the invention, the circuit breaker is designed in such a way that the level of the voltage across the electronic interruption unit can be advantageously determined. In other words, the level of a first voltage between the grid-side connection point EUG and the load-side connection point EUL of the electronic interruption unit EU can be determined or is determined.

For this purpose, in the example shown in FIG. 1, a first voltage sensor unit SUI connected to the control unit SE is provided, which determines the voltage level between the grid-side connection point EUG and the load-side connection point EUL of the electronic interruption unit EU.

When the voltage is measured by the first voltage sensor unit SUI, the voltage across the series connection of the electronic interruption unit EU and current sensor SI can alternatively be determined, as shown in FIG. 1. The current sensor unit SI has a very low internal resistance, so that the determination of the voltage level is unaffected or only negligibly affected.

Furthermore, a measuring impedance ZM can be connected between the grid-side connection points APLG, APNG of the mechanical isolating contact unit MK. The measuring impedance ZM can, for example, be an electrical resistor and/or capacitor. The measuring impedance can also be an inductor. In particular, the measuring impedance can be a series or parallel connection of a resistor and/or capacitor and/or inductor.

Advantageously, a second voltage sensor unit SU2 can be provided, which determines the voltage level between the grid-side neutral conductor connection NG and the grid-side phase conductor connection LG.

The first voltage sensor unit can also be replaced by using two voltage measurements (before the electronic interruption unit and after the electronic interruption unit). The voltage across the electronic interruption unit is determined by means of a difference formation.

For example, a second voltage sensor unit SU2 connected to the control unit SE can be provided, which determines the level of a second voltage between the grid-side neutral conductor connection (NG) and the grid-side phase conductor connection (LG). Furthermore, a third voltage sensor unit SU3 (not shown) connected to the control unit can be provided, which determines the level of a third voltage between the grid-side neutral conductor connection NG and the load-side connection point EUL of the electronic interruption unit EU. The circuit breaker is designed in such a way that the level of a first voltage between the grid-side connection point EUG and the load-side connection point EUL of the electronic interruption unit EU is determined from the difference between the second and third voltage.

In the example shown in FIG. 1, the electronic interruption unit EU has a single-pole design, in the example in the phase conductor. Here, the grid-side connection point APNG for the neutral conductor of the mechanical isolating contact unit MK is connected to the grid-side neutral conductor connection NG of the housing GEH.

The circuit breaker SG is advantageously designed in such a way that the contacts of the mechanical isolating contact unit MK can be opened by the control unit SE but not closed, which is indicated by an arrow from the control unit SE to the mechanical isolating contact unit MK.

The mechanical isolating contact unit MK can be operated by a mechanical handle HH on the circuit breaker SG to switch a manual (by hand) opening or closing of the contacts KKL, KKN. The mechanical handle HH indicates the switching state (open or closed) of the contacts of the mechanical isolating contact unit MK on the circuit breaker. Furthermore, the contact position (or the position of the handle, closed or open) can be transmitted to the control unit SE. The contact position (or the position of the handle) can be determined using a sensor, for example.

The mechanical isolating contact unit MK is advantageously designed in such a way that (manual) closing of the contacts by the mechanical handle is only possible after a release (enable), in particular a release signal. This is also indicated by the arrow from the control unit SE to the mechanical isolating contact unit MK. In other words, the contacts KKL, KKN of the mechanical isolating contact unit MK can only be closed by the handle HH when the release or the release signal (from the control unit) is present. Without the release or the release signal, the handle HH can be actuated, but the contacts cannot be closed (“continuous slipping”).

The circuit breaker SG has a power supply NT, for example a grid part. In particular, the power supply NT is provided for the control unit SE, which is indicated by a connection between the power supply NT and the control unit SE in FIG. 1. The power supply NT is (on the other hand) connected to the grid-side neutral conductor connection NG and the grid-side phase conductor connection LG. A fuse SS, in particular a melting fuse, can advantageously be provided in the connection to the grid-side neutral conductor connection NG (and/or phase conductor connection LG).

Alternatively, the measuring impedance ZM can be connected to the grid-side neutral conductor connection NG via the fuse SS. In this way, a three-pole electronic unit EE (FIG. 6) can be advantageously realized, for example as a module that contains three connection points, one neutral conductor connection point and two phase conductor connection points. The electronic unit EE has, for example, the electronic interruption unit EU, the control unit SE, the power supply NT (in particular including the fuse SS), the current sensor unit SI, the first voltage sensor unit SUI and optionally the second voltage sensor unit SU2.

The low-voltage circuit can be a three-phase AC circuit with a neutral conductor and three phase conductors. For this purpose, the circuit breaker can be designed as a three-phase variant and, for example, can have further grid-side and load-side phase conductor connections. Electronic interruption units and voltage detectors (e.g., by first voltage sensor units) according to the invention are provided in an analogous manner between the additional grid-side and load-side phase conductor connections. Likewise, contacts of the mechanical isolating contact unit are provided.

High-ohmic refers to a state in which only a current of negligible magnitude flows. In particular, high-ohmic refers to resistance values of greater than 1 kiloohm, preferably greater than 10 kiloohms, 100 kiloohms, 1 megaohm, 10 megaohms, 100 megaohms, 1 gigaohm or greater.

Low-ohmic refers to a condition in which the current value specified on the circuit breaker could flow. In particular, low-ohmic refers to resistance values that are less than 10 ohms, preferably less than 1 ohm, 100 ohm, milliohms, 10 milliohms, 1 milliohm or less.

FIG. 2 shows an illustration as in FIG. 1, with the difference that an energy source EQ with a nominal voltage UN of the low-voltage circuit is connected to the grid side GRID. Furthermore, a consumer or energy sink ES is connected to the load side LOAD.

Furthermore, a release signal is shown for the connection between the control unit SE and the mechanical isolating contact unit MK.

The mechanical isolating contact unit MK is shown in an open state OFF, i.e., with open contacts KKN, KKL to prevent current flow.

For example, the circuit breaker SG works in principle in such a way that when the contacts of the mechanical isolating contact unit are closed and the interruption unit is in the low-ohmic state and
when a current is detected that exceeds a first current value, in particular the first current value is exceeded for a first time limit, the electronic interruption unit EU becomes high-ohmic and the mechanical isolating contact unit MK remains closed,
when a current is detected that exceeds a higher second current value, in particular for a second time limit, the electronic interruption unit EU becomes high-ohmic and the mechanical isolating contact unit MK is opened,
if a current is detected that exceeds an even higher third current value, the electronic interruption unit becomes high-ohmic and the mechanical isolating contact unit MK is opened.

FIG. 3 shows a representation according to FIG. 2, with various differences. The voltages on and in the circuit breaker are shown in greater detail:
the nominal voltage UN of the energy source EQ of the low-voltage circuit,
the grid voltage UL applied between the grid-side neutral conductor connection NG and the grid-side phase conductor connection LG,
the second voltage U2 or U_{N,GND} measured in the circuit breaker by the second voltage sensor unit SU2,
the first voltage U1 or U_{SW} measured with the first voltage sensor unit SUI across the electronic interruption unit EU.

In this variant as shown in FIG. 3, the first voltage U1 (or U_{SW}) is measured directly across the electronic interruption unit (i.e., without current sensor unit SI). The second voltage U2 (or U_{N,GND}) corresponds to the grid voltage ULN minus the (minimum) voltage drop across the current sensor unit SI and the ohmic losses.

A detail of the electronic interruption unit EU is also shown, wherein the (single-pole) electronic interruption unit EU has semiconductor-based switch elements T1, T2. In the example shown in FIG. 3, two series-connected semiconductor-based switch elements T1, T2 are provided. An overvoltage protection device TVS is advantageously provided above the series connection of the two semiconductor-based switch elements T1, T2.

In the embodiment shown in FIG. 3, two unidirectional electronic switch elements are connected in series (anti-serially). The first unidirectional switch element is arranged to be switchable in a first current direction and the second unidirectional switch element is arranged to be switchable in the opposite current direction, wherein the unidirectional switch elements are conductive against their current switching direction (directly or indirectly, e.g., by internal or external diodes connected in parallel). In particular, the circuit breaker is designed in such a way that the first and second switch elements can be switched independently of each other.

FIG. 3 also shows a grid-side line inductance L_{grid} with associated voltage drop U_{Lgrid} and grid-side current i_{grid}. The load-side current i_{load} and the load-side voltage drop U_{Load} across the consumer or the energy sink ES are also shown. The energy sink ES is shown with its inductive and ohmic components.

The following situation is considered below:
nominal voltage or grid voltage (e.g., 230 V AC) is present at the grid-side connection LG, NG or grid-side GRID or grid connection of the circuit breaker,
a consumer or energy sink ES or load is connected to the load side LOAD of the circuit breaker.

FIG. 3 shows the difference that the contacts of the mechanical isolating contact unit are closed and the electronic interruption unit is high-ohmic.

The circuit breaker is designed such that when the contacts of the mechanical isolating contact unit MK are closed and the electronic interruption unit EU is switched to a high-ohmic state, the electronic interruption unit EU is switched to a low-ohmic state for a first period of time, then the level of the voltage across the electronic interruption unit is determined (in the low-ohmic state). If a first voltage threshold value is exceeded, a first fault condition is present which prevents (further) low-ohmic switching of the electronic interruption unit and/or initiates opening of the contacts.

This is indicated in FIG. 8 by the fact that the connection between control unit SE and electronic interruption unit EU has a square-wave signal that is in the “off” state and is briefly switched to the “on” state. This means that the electronic interruption unit EU is switched to a low-ohmic state briefly (first time period). If necessary, the electronic interruption unit can be switched to the low-ohmic state several times to test the functional capability, which is indicated, for example, by two successive “on” states of the square-wave signal.

If the first fault condition is present, an opening signal OEF is sent from the control unit SE to the mechanical isolating contact unit MK to initiate opening of the contacts, as indicated in FIG. 3. The opening of the mechanical contacts is preferably carried out shortly before the current zero crossing so that the mechanical switching contacts can interrupt the current flow more easily, and contact burn-off or arcing is avoided. Furthermore, the control unit SE can avoid or suppress a signal for the electronic interruption unit to become low-ohmic.

The electronic interruption unit is advantageously switched to a low-ohmic state when the instantaneous value of the voltage between the grid-side neutral conductor connection and the grid-side phase conductor connection falls below a second voltage threshold value.

It is advantageous to select the time for switching on at low instantaneous voltage values (less than the second voltage threshold) in order to minimize the resulting measuring current through the consumer/sink energy/load. Furthermore, to ensure personal protection. The second voltage threshold can be 50 V AC, for example. This means that only non-hazardous (protective) low voltages are used when switching on.

FIG. 3 shows the basic overview for testing the electronic interruption unit in a so-called control or standby state. In this state, the mechanical isolating contact unit is closed and the electronic interruption unit has a high impedance. The functionality of the switch elements T1 or T2 can be tested by briefly switching on the electronic interruption unit or its semiconductor-based switch elements, depending on the applied voltage polarity.

FIG. 4 shows voltage and current curves during the test by briefly switching on the electronic interruption unit (for a functional circuit breaker).

The vertical y-axis shows the voltage in volts or the current in mA and the horizontal x-axis shows the time in milliseconds ms.

In the upper graph of FIG. 9, a first switch-on pulse EI1 is shown at time t=10 ms and a second switch-on pulse EI2 of the semiconductor-based switch elements is shown at time t=20 ms.

The middle graph shows the load-side voltage curves U_{Load} and the load-side current curves i_{load} over the time t in ms. At the first switch-on pulse EI1 and at the second switch-on pulse AI2, a load-side current change or a current pulse can be detected in each case.

The graph below shows the curve of the first voltage U1 over the time t in ms. At the time of the first and second switch-on pulses EI1, EI2, a voltage change or voltage dip in the first voltage U1 can be seen, which can be detected (no exceeding of the first voltage threshold value). In the ideal case, the voltage across the electronic interruption unit is zero or close to zero volts after switch-on or during the switch-on duration (less than 1 volt). FIG. 9 shows an example of this for a functional device.

In the positive half-wave, for example, the switch element T2 can be tested. In the negative half-wave, for example, the switch element T1 can be tested.

FIG. 5 shows an illustration as in FIG. 4, with the difference that exemplary current and voltage curves are shown for a defective circuit breaker with a defective electronic interruption unit in which the semiconductor-based switch element T2 is burnt out.

In the middle graph, the current curve only shows asymmetrical deflections when switching on; furthermore, no voltage dip can be detected at the first voltage in the lower graph. The second voltage threshold has been exceeded. The first error condition is present. Opening of the contacts of the mechanical separating contacts unit is initiated in order to establish safety in the low-voltage circuit.

FIG. 6 shows a representation as in FIGS. 1-3, with the difference that the circuit breaker is constructed in two parts. It contains an electronic first part EPART, for example on a printed circuit board. The first part EPART can have the control unit SE, the first voltage sensor unit SUI, the second voltage sensor unit SU2, the current sensor unit SI, the electronic interruption unit EU, the power supply NT. Furthermore, the first part can have the fuse SS, a switch SCH, the measuring impedance ZM, a temperature sensor TEM (in particular for the electronic interruption unit EU), a communication unit COM, a display unit DISP.

The first part EPART has only three connections:
the grid-side phase conductor connection LG,
a connection for or to the grid-side phase conductor connection point APLG of the mechanical isolating contact unit MK,
a connection for a connection to the grid-side neutral conductor connection NG.

The circuit breaker contains a second part MPART, in particular a mechanical part. The second part MPART can have the mechanical isolating contact unit MK, the handle HH and a release unit FG. Furthermore, the second part can have a position unit POS, for reporting the position of the contacts of the mechanical isolating contact unit MK to the control unit, as well as the (neutral conductor) connection(s). Further, unspecified units may be provided.

The division into two parts makes it possible to advantageously realize a compact circuit breaker according to the invention.

The release unit FG causes the actuation of the contacts of the mechanical isolating contact unit to be released by the handle HH when a release signal is present in enable. Furthermore, the release unit FG can cause the contacts to open if an opening signal OEF is present. The release unit then acts as a trigger unit.

The invention is summarized and explained in greater detail below.

Proposed by way of example is an electronic protection and switching device with:
a housing with grid-side and load-side connections
a voltage sensor unit for measuring the grid voltage
a current sensor unit for measuring the (load) current
a mechanical isolating contact unit incl. handle (incl. display of contact position, release by the electronics, isolating properties)
electronic interruption unit with semiconductor-based switch elements
control unit
the functional capability of the electronic interruption unit is tested
   by switching the electronic interruption unit on briefly (<10 ms, preferably <1 ms) and off again immediately
   and simultaneously recording measured voltage values and/or measured current values and analyzing these in such a way that a blown or burnt-out electronic interruption unit is detected or blown or burnt-out switch elements are detected.

A first voltage sensor unit/voltage measuring unit is proposed above the electronic disconnection unit in order to determine the voltage across the electronic disconnection unit. Alternatively, a third voltage sensor unit can be provided parallel to the second voltage sensor unit, which is provided at the load-side connection of the electronic interruption unit, i.e., between the electronic interruption unit and the mechanical separating contacts contact unit, wherein this is connected to the phase conductor on the one hand and to the neutral conductor on the other. The first voltage can be determined from the difference of the voltages between the second and third voltage sensor units. The first voltage sensor unit can be omitted in this case.

A computer program product or algorithm is proposed which switches the electronic: interruption unit or the semiconductor-based switch elements on and off at suitable times (instantaneous values of the grid voltage) and simultaneously evaluates the measured current and voltage values in order to recognize that the electronic interruption unit is functional or non-functional.

The control unit SE can have a microcontroller (for this purpose). The computer program product can be executed on the microcontroller. The computer program product comprises instructions which, when the program is executed by the microcontroller, cause the microcontroller to control the circuit breaker, in particular to support the method according to the invention, in particular to carry it out.

The computer program product can be stored on a computer-readable storage medium, such as a CD-ROM, a USB stick or similar.

Furthermore, a data carrier signal that transmits the computer program product may exist.

The time for switching the semiconductor-based switch elements (for testing) is based on the polarity of the currently applied grid voltage so that individual switch elements can be tested in a targeted manner. Furthermore, the instantaneous value of the voltage can be taken into account when selecting the time.

In summary:
voltage measurement across the electronic interruption unit or determination of the voltage drop across the electronic interruption unit EU (e.g., via a simple voltage divider),
voltage detection across the electronic interruption unit will be used to: detect a blown or burnt-out state of a power semiconductor
possibility of opening the mechanical isolating contact unit after detecting a fault in the electronic interruption unit.

Although the invention has been illustrated and described in detail by the exemplary embodiment, the invention is not limited by the disclosed examples and other variations May be derived by a person skilled in the art without departing from the scope of protection of the invention.

1-19. (canceled)

20. A circuit breaker for protecting an electric low-voltage circuit, the circuit breaker comprising:
a housing having at least one grid-side connection and at least one load-side connection;
an electronic interruption unit being associated with said at least one grid-side connection;
a mechanical isolating contact unit connected in series with said electronic interruption unit, said mechanical isolating contact unit being associated with said at least one load-side connection;
said mechanical isolating contact unit having contacts opening to prevent a current flow or closing to permit a current flow in the low-voltage circuit;
said electronic interruption unit having semiconductor-based switch elements configured to be switched into a high-ohmic state to prevent a current flow or into a low-ohmic to permit a current flow in the low-voltage circuit;
a current sensor unit for determining a current level in the low-voltage circuit;
a control unit connected to said current sensor unit, to said mechanical isolating contact unit and to said electronic interruption unit, for initiating prevention of a current flow of the low-voltage circuit upon exceeding at least one of current or current/time limit values; and
said electronic interruption unit being switched to a low-ohmic state for a first period of time to test functionality of the circuit breaker upon said contacts of said mechanical isolating contact unit being closed and said electronic interruption unit being switched to a high-ohmic state.

21. The circuit breaker according to claim 20, wherein a voltage level across said electronic interruption unit can be determined for a conductor.

22. The circuit breaker according to claim 21, wherein:
the voltage level across said electronic interruption unit is determined upon said electronic interruption unit being switched to the low-ohmic state for the first period of time; and
a first fault condition is present upon exceeding a first voltage threshold value, causing at least one of a further low-ohmic state of said electronic interruption unit to be avoided or opening of said contacts to be initiated.

23. The circuit breaker according to claim 22, wherein said electronic interruption unit is switched to the low-ohmic state upon an instantaneous value of a voltage between a grid-side neutral conductor connection and a grid-side phase conductor connection falling below a second voltage threshold value.

24. The circuit breaker according to claim 20, which further comprises a first voltage sensor unit connected to said control unit for determining a level of a first voltage between a grid-side connection point and a load-side connection point of said electronic interruption unit.

25. The circuit breaker according to claim 24, which further comprises:
a second voltage sensor unit connected to said control unit for determining a level of a second voltage between a grid-side neutral conductor connection and a grid-side phase conductor connection; and
a third voltage sensor unit connected to said control unit for determining a level of a third voltage between the grid-side neutral conductor connection and the load-side connection point of said electronic interruption unit; and
the level of the first voltage between the grid-side connection point and the load-side connection point of said electronic interruption unit being determined from a difference between the second and third voltages.

26. The circuit breaker according to claim 20, wherein said current sensor unit is provided on a circuit side between a grid-side phase conductor connection and a load-side phase conductor connection.

27. The circuit breaker according to claim 20, which further comprises:
a plurality of grid-side and load-side phase conductor connections for a low-voltage circuit being a three-phase alternating current circuit;
a contact of said mechanical isolating contact unit and electronic interruption units being provided between each of said plurality of grid-side and load-side phase conductor connections; and
first voltage sensor units for determining a voltage level across said respective electronic interruption units.

28. The circuit breaker according to claim 20, wherein said control unit is configured to open but not to close said contacts of said mechanical isolating contact unit.

29. The circuit breaker according to claim 20, which further comprises a mechanical handle for operating said mechanical isolating contact unit to switch an opening or a closing of said contacts.

30. The circuit breaker according to claim 20, which further comprises a power supply for said control unit, said power supply being connected to a grid-side neutral conductor connection and a grid-side phase conductor connection, and a fuse or a melting fuse provided in a connection to said grid-side neutral conductor connection.

31. The circuit breaker according to claim 20, wherein, upon said contacts of said mechanical isolating contact unit being closed and said electronic interruption unit having the low-ohmic state:
said electronic interruption unit has the high-ohmic state and said mechanical isolating contact unit remains closed, upon detecting a current exceeding a first current value for a first time limit;
said electronic interruption unit has the high-ohmic state and said mechanical isolating contact unit is opened, upon detecting a current exceeding a second current value for a second time limit; and
said electronic interruption unit has the high-ohmic state and said mechanical isolating contact unit is opened, upon detecting a current exceeding a third current value.

32. The circuit breaker according to claim 20, wherein said control unit has a microcontroller.

33. A method for operating a circuit breaker for protecting an electric low-voltage circuit, the method comprising:
providing a housing having at least one grid-side connection and at least one load-side connection;
providing an electronic interruption unit being associated with the at least one grid-side connection and having semiconductor-based switch elements;
connecting a mechanical isolating contact unit in series with the electronic interruption unit, the mechanical isolating contact unit being associated with the at least one load-side connection and having contacts;
switching the mechanical isolating contact unit by opening the contacts to prevent a current flow or by closing the contacts to allow a current flow in the low-voltage circuit;
switching the semiconductor-based switch elements of the electronic interruption unit into a high-ohmic state to prevent a current flow or into a low-ohmic state to allow a current flow in the low-voltage circuit;
determining a current level in the low-voltage circuit between the at least one grid-side phase conductor connection and the at least one load-side phase conductor connection;
preventing a current flow in the low-voltage circuit upon exceeding at least one of current or current-time limit values; and
switching the electronic interruption unit to a low-ohmic state for a first period of time for functional testing of the circuit breaker with the contacts of the mechanical isolating contact unit being closed and the electronic interruption unit being switched to a high-ohmic state.

34. The method according to claim 33, which further comprises:
determining a voltage level across the electronic interruption unit when the electronic interruption unit is switched to the low-ohmic state for the first period of time; and
at least one of avoiding a further low-ohmic state of the electronic interruption unit or initiating opening of the contacts, upon a first fault condition being present when a first voltage threshold value is exceeded.

35. The method according to claim 34, which further comprises switching the electronic interruption unit to a low-ohmic state when an instantaneous value of a voltage between a grid-side neutral conductor connection and a grid-side phase conductor connection falls below a second voltage threshold value.

36. A non-transitory computer program product comprising instructions which, upon execution of the program by a microcontroller, cause the microcontroller to support or carry out the method according to claim 33 with a circuit breaker for protecting an electric low-voltage circuit, the circuit breaker including:
a housing having at least one grid-side connection and at least one load-side connection;
an electronic interruption unit being associated with the at least one grid-side connection;
a mechanical isolating contact unit connected in series with the electronic interruption unit, the mechanical isolating contact unit being associated with the at least one load-side connection;
the mechanical isolating contact unit having contacts opening to prevent a current flow or closing to permit a current flow in the low-voltage circuit;
the electronic interruption unit having semiconductor-based switch elements configured to be switched into a high-ohmic state to prevent a current flow or into a low-ohmic to permit a current flow in the low-voltage circuit;
a current sensor unit for determining a current level in the low-voltage circuit;
a control unit connected to the current sensor unit, to the mechanical isolating contact unit and to the electronic interruption unit, for initiating prevention of a current flow of the low-voltage circuit upon exceeding at least one of current or current/time limit values; and
the electronic interruption unit being switched to a low-ohmic state for a first period of time to test functionality of the circuit breaker upon the contacts of the mechanical isolating contact unit being closed and the electronic interruption unit being switched to a high-ohmic state.

37. A non-transitory computer-readable storage medium on which the computer program product according to claim 36 is stored.

38. A data carrier signal transmitting the non-transitory computer program product according to claim 36.
